(19) United States
(12) Patent Application Publication
(10) Pub. No.: US 2016/0242560 A1
(43) Pub. Date: Aug. 25, 2016

(54) SEATING FURNITURE

(71) Applicant: HIMOLLA POLSTERMOEBEL GMBH, TAUFKIRCHEN/VILS (DE)

(72) Inventor: JOHANN AIGNER, TAUFKIRCHEN/VILS (DE)

(73) Assignee: HIMOLLA POLSTERMOEBEL GMBH, TAUFKIRCHEN/VILS (DE)

(21) Appl. No.: 15/046,459

(22) Filed: Feb. 18, 2016

(30) Foreign Application Priority Data
Feb. 20, 2015 (DE) 10 2015 102 493.4

(51) Int. Cl. A47C 21/04; A47C 17/86; H01R 13/73; A47C 17/165

(52) U.S. Cl. CPC A47C 21/048; A47C 17/165; A47C 17/86; H01R 13/73

(57) ABSTRACT

An item of seating furniture includes a basic frame comprising a rear wall, at least one seat part arranged on the basic frame, at least one back part connected to the rear wall of the basic frame, and a plug receptacle integrated in the rear wall or in the at least one back part. The at least one back part is configured to be adjusted between a seated position in which the at least one back part is upright, and a folded-forward position in which the at least one back part is folded-forward. The plug receptacle is arranged to be concealed in the seated position and to be accessible in the folded-forward position.

### CROSS REFERENCE TO PRIOR APPLICATIONS

Priority is claimed to German Patent Application No. DE 10 2015 102 493.4, filed Feb. 20, 2015. The entire disclosure of said application is incorporated by reference herein.

### FIELD

The present invention relates to an item of seating furniture, in particular to an item of upholstered furniture, such as a sofa, comprising a basic frame which has a rear wall, at least one seat part, and at least one back part.

### BACKGROUND

Electrical devices, such as heating pads, electric blankets, foot warmers and the like, which are suitable for use on a sofa and which must be supplied with power, have previously been described for private use. In addition thereto, rechargeable batteries of mobile devices, such as notebooks, smartphones, tablets and the like, only have a comparatively short run time and must therefore be regularly recharged. Recharging in particular occurs at home while the device is at the same time being operated, for which purpose a corresponding power supply is also required.

### SUMMARY

An aspect of the present invention is to facilitate the use of electrical devices on a sofa and the like.

In an embodiment, the present invention provides an item of seating furniture which includes a basic frame comprising a rear wall, at least one seat part arranged on the basic frame, at least one back part connected to the rear wall of the basic frame, and a plug receptacle integrated in the rear wall or in the at least one back part. The at least one back part is configured to be adjusted between a seated position in which the at least one back part is upright, and a folded-forward position in which the at least one back part is folded-forward. The plug receptacle is arranged to be concealed in the seated position and to be accessible in the folded-forward position.

### BRIEF DESCRIPTION OF THE DRAWINGS

The present invention is described in greater detail below on the basis of embodiments and of the drawings in which:

FIG. 1 shows a sectional view of an item of seating furniture according to the present invention comprising a back part in a seated position; and

FIG. 2 shows the item of seating furniture from FIG. 1 where the back part is folded over in the forward direction.

### DETAILED DESCRIPTION

The present invention provides an item of seating furniture, in particular a sofa, comprising a basic frame which has a rear wall, at least one seat part, at least one back part which can be adjusted between a seated position and a folded-forward position, and a plug receptacle which is integrated in the rear wall, in particular on the front face of the rear wall, or the back part, in particular on the rear face of the back part, and which is concealed, in particular by the back part or the rear wall, in the seated position, and which is accessible in the folded-forward position.

The abovementioned electrical devices and further electrical devices can therefore be plug-connected directly to a plug receptacle which is provided on or in the item of seating furniture, i.e., the electrical devices need not be supplied with power from a plug receptacle which is installed in a fixed manner in a wall via an extension cable. The risk of an accident, for example, by tripping over the extension cable, can thereby be precluded. The plug receptacle is not restricted to a plug receptacle within the meaning of a power connection socket, but may also include, for example, a plug receptacle in the field of data transmission, in particular for a network connection, or a combination of such connections. A plug receptacle can very generally be understood to be an electrical plug connector between electrical lines.

The present invention does not, however, only involve providing an item of seating furniture comprising a plug receptacle, but in particular involves not providing the plug receptacle at an arbitrary location on the item of seating furniture, but rather specially providing the plug receptacle in the rear wall or the back part so that the plug receptacle is not openly accessible in the seated position or in the folded-in position, but is rather arranged in a concealed manner so that higher safety requirements are in particular also met. It is in particular made difficult for small children to reach the plug receptacle. The plug receptacle is furthermore protected against shocks and largely also against dust and dirt in the seated position. The plug receptacle is freely accessible only in the folded-forward or in the folded-open position. This then makes it in particular possible for a plug to be plugged into the plug receptacle. A plug receptacle which is always visible on an item of seating furniture may additionally provide a disadvantageous visual impression.

In an embodiment of the present invention, the plug receptacle can, for example, be integrated in the rear wall. When the back part is adjusted between the seated position and the folded-forward position, the plug receptacle, and therefore also a mains connection cable, via which the plug receptacle which is integrated in the item of seating furniture can be connected to a wall plug receptacle, remain stationary. Tensile loads and pressure loads in the connection region of the mains connection cable to the plug receptacle which is integrated in the item of seating furniture can therefore be avoided when the back part is adjusted. It is, however, in principle also possible to also integrate the plug receptacle in the back part.

The folded-forward position can, for example, be a storage position in which the rear face of the back part forms a storage area. By way of example, a notebook can then be placed directly on the storage area and plugged into the plug receptacle in the immediate vicinity of the storage area, for example, in order to allow the notebook to be recharged and operated simultaneously. The storage area can, for example, be used to set down electrical devices which are inserted into the plug receptacle or to set down other articles, such as, for example, beverages. A choice therefore exists between a seated option and a storage option with a plug receptacle.

Particularly when the rear face of the back part forms a storage area, the rear face of the back part can, for example, be at least partially flat and/or the rear face of the back part can, for example, run at least substantially horizontally in the folded-forward position in order to provide an article the greatest possible solid standing position on the storage area.

In an embodiment of the present invention, the back part can, for example, have a storage plate on its rear face, the storage plate forming the storage area of the back part. In this case, the storage plate can, for example, be inserted into a recess which is formed on the rear face of the back part and be fastened in the recess, for example, so that the storage plate is integrated in the back part so that it is at least substantially flush with the outside of the back part. The storage plate can, for example, be concealed by the rear wall in the seated position. The item of seating furniture can thereby be positioned in the room in a freestanding manner without the storage plate being visible when looking at the item of seating furniture from the rear.

In an embodiment of the present invention, the back part can, for example, rest on the seat part in the folded-forward position. For this reason, the back part is also very stable in the folded-forward position. The back part can therefore also be loaded with a comparatively high weight in the folded-forward position without a supporting and/or folding mechanism, via which the back part is fastened to the basic frame, being damaged.

In an embodiment of the present invention, the plug receptacle can, for example, be inserted on the front face of the rear wall in a recessed manner. The plug receptacle is in particular inserted into a receptacle which is formed in the front face of the rear wall and which is fastened in the receptacle, for example, so that the storage plate is integrated in the rear wall so that it is at least substantially flush with the outside of the rear wall. The back part can therefore bear against the rear wall without spacing or deformation in the region of the plug receptacle in the seated position. It is in principal also possible for the incorporated plug receptacle to project outward beyond the front face of the rear wall to a greater or lesser extent.

In an embodiment of the present invention, the plug receptacle can, for example, be provided with a plug receptacle covering, in particular a folding cover or a sliding cover. A certain degree of security for the plug receptacle which is incorporated into the item of seating furniture can thereby be achieved . Such an arrangement can in particular at least largely prevent liquid from entering the interior of the plug receptacle in the event of, for example, a glass which is set down on the rear face of the back part accidentally tipping over.

In an embodiment of the present invention, the plug receptacle can, for example, be provided as a multifunctional plug receptacle. By way of example, the plug receptacle can have at least one power connection socket for a mains plug, one or more USB connection sockets, and/or a network connection, and/or a plurality of network connections. A plurality of electrical devices can therefore be operated and/or charged from the plug receptacle next to one another at the same time. In addition to the one plug receptacle, the item of seating furniture can have further plug receptacles which can each likewise be integrated in the rear wall or the one or another back part or else be provided at another location.

In an embodiment of the present invention, the plug receptacle can, for example, be connected to a mains connection cable which, starting from the plug receptacle, is routed downward within the rear wall and exits from the basic frame at a bottom face of the basic frame. The mains connection cable can, for example, be stowed away well within the rear wall and so as not to be visible from the outside. The situation of the mains connection cable openly hanging down from the rear face of the rear wall can be avoided by the mains connection cable being guided within the rear wall and exiting at the bottom face of the basic frame. In this case, the mains connection cable can, for example, be fastened to the basic frame via a strain-relief device. The connection between the mains connection cable and the plug receptacle which is integrated in the item of seating furniture can thereby be protected against tensile loading.

A folding fitting, in particular a lift-and-fold fitting, via which the back part is connected in an articulated manner to the basic frame, is in particular provided.

In an embodiment of the present invention, the item of seating furniture can, for example, be a multiseater, in particular a multiseater corner sofa, having a plurality of seat elements which each comprise at least one seat part and optionally a back part. In this case, at least one seat part then comprises a back part as described above and a plug receptacle as described above. One seat element can then be used as a storage area to supply power and/or as a network connection, and another seat element can be used as a seat area. The back part, which can be folded forward, and the plug receptacle can, for example, then be provided in an intermediate element of the multiseater. People sitting on both sides of the intermediate element can in this case reach the storage area and/or the plug receptacle.

An example of the present invention will be described below under reference to the drawings.

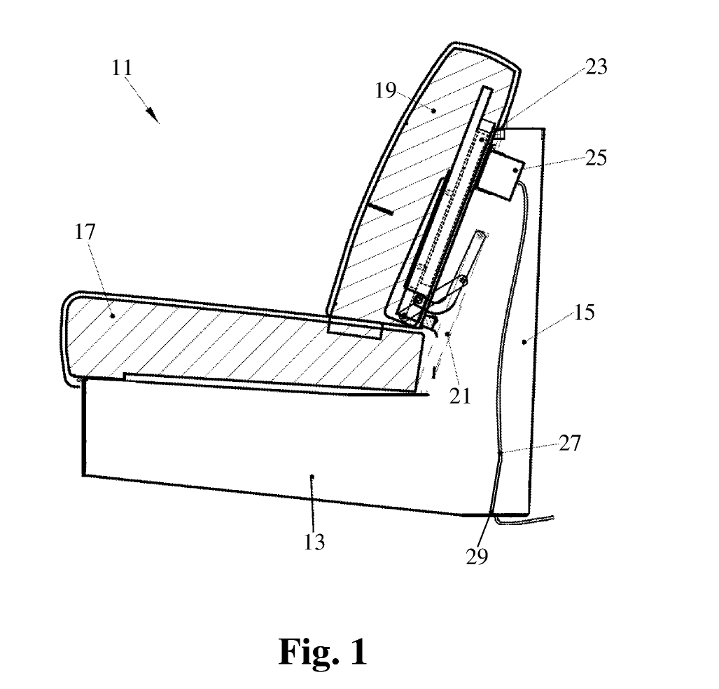

FIG. 1 shows a section through a seat element which is a constituent part of an item of seating furniture 11, in particular a multiseater, for example, a three-seater sofa or a corner sofa, having a plurality of seat elements which are arranged next to one another. The illustrated seat element is, for example, an intermediate element of a corner sofa, i.e., a seat element which is arranged between two further seat elements.

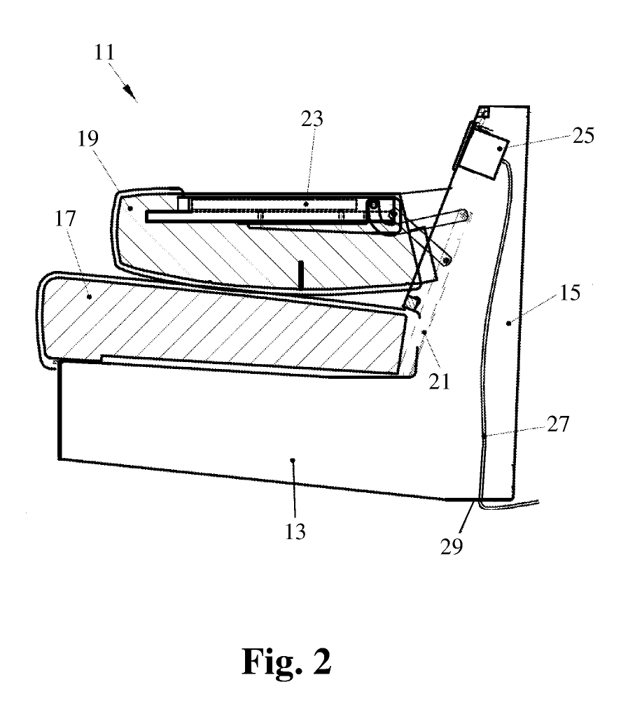

The seat element comprises a basic frame or a body 13 with a rear wall 15, a seat part 17 which is arranged so that it lies on the basic frame 13, and a back part 19 which is pivotably mounted on the basic frame 13 via a lift-and-fold fitting 21 of which the manner of operation has in principle previously been described. In this case, the back part 19 can be folded over in the forward direction from the seated position shown in FIG. 1, in which seated position the back part 19 bears against the rear wall 15, to the position shown in FIG. 2 in which the back part 19 rests on the top face of the seat part 17 by way of its front face.

In the folded-forward position shown in FIG. 2, the rear face of the back part 19, which rear face is for the most part flat, runs horizontally and therefore provides a storage area on which articles can be set down, in particular by a person sitting on another seat element of the item of seating furniture 11. In this case, the storage area is provided by a storage plate 23 which is inserted into a corresponding receptacle which is formed on the rear face of the back part 19 and which terminates flush with the outside of the rear face of the back part 19. As is clear from FIG. 2, the storage plate 23 is concealed by the rear wall 15 and is therefore not visible (in contrast to the situation in the storage position of the back part 19 according to FIG. 1) in the seated position of the back part 19, i.e., when the back part 19 is folded in.

A plug receptacle 25 is integrated in the rear wall 15 on the front face of the rear wall 15. The plug receptacle 25 is in this case inserted into a corresponding recess which is formed on the front face of the rear wall 15 and which terminates flush with the outside of the front face of the rear wall 15. As is clear from FIGS. 1 and 2, the plug receptacle 25 is arranged behind the back part 19 and is concealed by the back part 19. It is therefore not visible in the seated position shown in FIG. 1, but is freely accessible in the folded-forward position according to FIG. 2, so that an electrical device can then be plugged into the plug receptacle 25.

The plug receptacle 25 can, for example, be covered by a folding cover or sliding cover, which is not specifically shown in FIGS. 1 and 2. The plug receptacle 25 may in particular be a multifunctional plug receptacle which can provide more than only one single power connection socket for a mains plug, a USB connection socket, and/or a network connection, so that a plurality of electrical devices can also be connected to the plug receptacle 25 simultaneously. The electrical device or electrical devices which is/are plugged into the plug receptacle 25 can then be set down, in particular, on the storage area which is formed by the storage plate 23.

The plug receptacle 25 can be connected to a power supply, in particular to a wall plug receptacle which is not shown, via a mains connection cable 27. The mains connection cable 27 is routed downward in the interior of the rear wall 15 and is routed out of the basic frame 13 at the bottom face thereof. A strain-relief device 29 is provided to protect the electrical connection between the plug receptacle 25 and the mains connection cable 27 against loading due to the mains connection cable 27 being pulled, the strain-relief device being arranged on the bottom face of the basic frame 13 or at the point at which the mains connection cable 27 exits from the item of seating furniture 11 or from the basic frame 13.

In the item of seating furniture according to the present invention, a plug receptacle is visible when the back part is folded over in the forward direction, it then being possible for the plug receptacle to be used for plugging in, in particular for operating and recharging electrical devices, in particular by people sitting on the item of seating furniture.

The present invention is not limited to embodiments described herein; reference should be had to the appended claims.

### LIST OF REFERENCE SYMBOLS

11 Item of seating furniture
13 Basic frame
15 Rear wall
17 Seat part
19 Back part
21 Lift-and-fold fitting
23 Storage plate
25 Plug receptacle
27 Mains connection cable
29 Strain-relief device

What is claimed is:

1. An item of seating furniture comprising:
a basic frame comprising a rear wall;
at least one seat part arranged on the basic frame;
at least one back part connected to the rear wall of the basic frame, the at least one back part being configured to be adjusted between a seated position in which the at least one back part is upright, and a folded-forward position in which the at least one back part is folded-forward; and
a plug receptacle integrated in the rear wall or in the at least one back part, the plug receptacle being arranged to be concealed in the seated position and to be accessible in the folded-forward position.

2. The item of seating furniture as recited in claim 1, wherein the item of seating furniture is a sofa.

3. The item of seating furniture as recited in claim 1, wherein the at least one back part comprises a back part rear face, and the folded-forward position of the at least one back part provides a storage position in which the back part rear face forms a storage area.

4. The item of seating furniture as recited in claim 3, further comprising a storage plate arranged on the back part rear face, the storage plate forming the storage area of the at least one back part.

5. The item of seating furniture as recited in claim 4, wherein the storage plate is concealed by the rear wall in the seated position.

6. The item of seating furniture as recited in claim 1, wherein the rear wall comprises a rear wall front face, and the plug receptacle is inserted into the rear wall on the rear wall front face in a recessed manner.

7. The item of seating furniture as recited in claim 1, wherein the plug receptacle comprises a plug receptacle covering.

8. The item of seating furniture as recited in claim 7, wherein the plug receptacle covering is provided as a folding cover, a sliding cover, and/or as a multifunctional plug receptacle.

9. The item of seating furniture as recited in claim 1, wherein,
the basic frame comprises a basic frame bottom face, and
further comprising a mains connection cable connected to the plug receptacle, the mains connection cable being routed from the plug receptacle downward within the rear wall so as to exit from the basic frame at the basic frame bottom face.

10. The item of seating furniture as recited in claim 9, further comprising a strain-relief device which is configured to fasten the mains connection cable to the basic frame.

11. The item of seating furniture as recited in claim 1, wherein the item of seating furniture is provided as a multiseater comprising a plurality of seat elements, each of the plurality of seat elements comprising at least one seat part.

12. The item of seating furniture as recited in claim 11, wherein the multiseater further comprises a back part.

13. The item of seating furniture as recited in claim 12, wherein the multiseater comprises an intermediate element as the rear wall or the at least one back part, and the plug receptacle is arranged in the intermediate element.
